(19) United States
(12) Patent Application Publication
(10) Pub. No.: US 2024/0052148 A1
(43) Pub. Date: Feb. 15, 2024

(54) POLYOLEFIN COMPOSITION FOR FUNCTIONAL FILMS

(71) Applicant: Basell Poliolefine Italia S.r.l., Milano (IT)

(72) Inventors: Carl Gunther Schirmeister, Denzlingen (DE); Erik Hans Licht, Mainz (DE); Yannic Kessler, Kriftel (DE); Klaus Klemm, Mainz (DE); Karsten Schmitz, Hofheim/Ts. (DE); Mikhail Dureev, Butzbach (DE); Frederik Thoma, Kamp-Lintfort (DE); Klaus Müller, Sulzbach (DE)

(73) Assignee: Basell Poliolefine Italia S.r.l., Milano (IT)

(21) Appl. No.: 18/264,632

(22) PCT Filed: Jan. 12, 2022
(86) PCT No.: PCT/EP2022/050537

§ 371 Date: Aug. 8, 2023

(30) Foreign Application Priority Data
Feb. 8, 2021 (EP) 21155750.9

(51) Int. Cl. C08L 23/12; C08J 5/18; B32B 27/32; B32B 27/08; B32B 15/085; B32B 15/20; B32B 27/18

(52) U.S. Cl. CPC C08L 23/12; C08J 5/18; B32B 27/32; B32B 27/08; B32B 15/085; B32B 15/20; B32B 27/18; C08L 2205/03; C08J 2323/12; C08J 2451/00; C08J 2461/28; C08J 2423/10; B32B 2270/00; B32B 2250/03; B32B 2307/748; B32B 2307/7376

(57) ABSTRACT

A polymer blend obtained by melt blending a mixture made from or containing:
(A) 60% to 98.8% by weight of a polyolefin;
(B) 0.1% to 30% by weight of a compatibilizer;
(C) 0.05% to 20% by weight of an amino resin; and
(D) 0% to 5% by weight of an additive,
wherein the amounts of (A), (B), (C), and (D) are based on the total weight of (A)+(B)+(C)+(D), the total weight being 100%.

### FIELD OF THE INVENTION

In general, the present disclosure relates to the field of chemistry. More specifically, the present disclosure relates to polymer chemistry. In particular, the present disclosure relates to a polyolefin composition and articles made therefrom.

### BACKGROUND OF THE INVENTION

Multilayer articles have two or more layers of the same or different materials. In some instances, the materials include films, sheets, tapes, and moldings of thermoplastic, thermosetting, or elastomeric polymers, foils of metals, paper, woven or nonwoven fabrics, glass, wood, or leather. In some instances, the metals are aluminum or steel.

In some instances, multilayer articles have intermediate layers for adhering the other layers.

### SUMMARY OF THE INVENTION

In a general embodiment, the present disclosure provides a polymer blend obtained by melt blending a mixture made from or containing:
(A) 60% to 98.8% by weight of a polyolefin;
(B) 0.1% to 30% by weight of a compatibilizer;
(C) 0.05% to 20% by weight of an amino resin; and
(D) 0% to 5% by weight of an additive,
   wherein the amounts of (A), (B), (C), and (D) are based on the total weight of (A)+(B)+(C)+(D), the total weight being 100%.

In some embodiments, the present disclosure provides a film or sheet made from or containing the polymer blend. In some embodiments, the present disclosure provides a multilayer article made from or containing a backing layer, an upper layer, and a bonding layer interposed between the backing layer and the upper layer, wherein the backing layer is made from or containing a thermoplastic polymer, the bonding layer is made from or containing the film or sheet, and the upper layer is made from or containing a material selected from the group consisting of metals, polymers, glass, ceramic, wood, wood-like materials, leather, cork, paper, linoleum, and combinations thereof.

In some embodiments, the present disclosure provides a process for preparing the multilayer article selected from the group consisting of coextrusion, lamination, hot press molding, back injection molding, back foaming, back compression molding, and combinations thereof

In some embodiments, the film layer bonds a metallic layer to a polyolefin layer.

While multiple embodiments are disclosed, still other embodiments will become apparent to those skilled in the art from the following detailed description. As will be apparent, certain embodiments, as disclosed herein, are capable of modifications in various aspects, without departing from the spirit and scope of the claims as presented herein. Accordingly, the following detailed description is to be regarded as illustrative in nature and not restrictive.

### DETAILED DESCRIPTION OF THE INVENTION

In the present description and in the appended claims, the percentages are expressed by weight, unless otherwise specified.

In the context of the present description and of the appended claims, when the term “comprising” is referred to a polymer or to a polyolefin composition, mixture, or blend, the term should be construed to mean “comprising or consisting essentially of”.

In the context of the present disclosure, the term “consisting essentially of” means that, in addition to the specified components, the polymer, the polyolefin composition, the polyolefin mixture, or the polyolefin blend may be further made from or containing other components, provided that the characteristics of the polymer or of the composition, mixture or blend are not materially affected by the presence of the other components. In some embodiments, the other components are catalyst residues.

As used herein, the term “film” refers to a layer of material having a thickness equal to or lower than 5000 μm.

As used herein, the term “sheet” refers to a layer of material having a thickness greater than 5000 μm.

In some embodiments, component (A) is a propylene polymer selected from the group consisting of propylene homopolymers, propylene copolymers, and propylene heterophasic polymers. In some embodiments, component (A) is a propylene polymer selected from the group consisting of propylene homopolymers and propylene copolymers with an alpha-olefin of formula CH₂═CHR, where R is H or a linear or branched C2-C8 alkyl. In some embodiments, the propylene copolymer is made from or containing up to 6.0% by weight, alternatively 0.5-6.0% by weight, alternatively 0.5-5.0% by weight, of units deriving from the alpha-olefin, based on the weight of (A).

In some embodiments, the alpha-olefin is selected from the group consisting of ethylene, butene-1, hexene-1, 4-methyl-pentene-1, octene-1, and combinations thereof. In some embodiments, the alpha-olefin is ethylene.

In some embodiments, component (A) is a propylene homopolymer.

In some embodiments, component (A) has at least one of the following properties:
MFR(A), determined according to the method ISO 1133 (230° C., 2.16 kg), ranging from 0.5 to 200 g/10 min., alternatively from 1 to 100 g/10 min., alternatively from 3 to 70 g/10 min., alternatively from 5 to 30 g/10 min.;
lower than 12.0% by weight, alternatively lower than 10% by weight, alternatively lower than 5% by weight, alternatively lower than 3% by weight, of a fraction soluble in xylene at 25° C. XS(A), based on the weight of the component (A); and
tensile modulus, measured according to the method DIN EN ISO 527-1, −2 at 23° C., ranging from 1200 to 2000 MPa, alternatively from 1300 to 1600 MPa.

In some embodiments, component (A) has the properties above. In some embodiments, component (A) is a propylene polymer, alternatively a propylene homopolymer, with the properties above.

In some embodiments, polyolefins for use as component (A) are commercially available. In some embodiments, polyolefins for use as component (A) are obtained by polymerizing the monomers in the presence a catalyst selected from the group consisting of metallocene compounds, highly stereospecific Ziegler-Natta catalyst systems, and combinations thereof

In some embodiments, the polymerization process to prepare component (A) is carried out in the presence of a highly stereospecific Ziegler-Natta catalyst system made from or containing:
(1) a solid catalyst component made from or containing a magnesium halide support on which a Ti compound having a Ti-halogen bond is present, and a stereoregulating internal donor;
(2) optionally, an Al-containing cocatalyst; and
(3) optionally, a further electron-donor compound (external donor).

In some embodiments, the solid catalyst component (1) is made from or containing TiCl₄ in an amount securing the presence of from 0.5 to 10% by weight of Ti with respect to the total weight of the solid catalyst component (1).

In some embodiments, the solid catalyst component (1) is made from or containing a stereoregulating internal electron donor compound selected from mono or bidentate organic Lewis bases. In some embodiments, the solid catalyst component (1) is made from or containing a stereoregulating internal electron donor compound selected from the group consisting of esters, ketones, amines, amides, carbamates, carbonates, ethers, nitriles, alkoxysilanes, and combinations thereof

In some embodiments, the donors are the esters of phthalic acids. In some embodiments, the esters of phthalic acids are as described in European Patent Application Nos. EP45977A2 and EP395083A2. In some embodiments, the esters of phthalic acids are selected from the group consisting of di-isobutyl phthalate, di-n-butyl phthalate, di-n-octyl phthalate, diphenyl phthalate, benzylbutyl phthalate, and combinations thereof

In some embodiments, the esters of aliphatic acids are selected from the group consisting of esters of malonic acids, esters of glutaric acids, and esters of succinic acids. In some embodiments, the esters of malonic acids are as described in Patent Cooperation Treaty Publication Nos. WO98/056830, WO98/056833, and WO98/056834. In some embodiments, the esters of glutaric acids are as described in Patent Cooperation Treaty Publication No. WO00/55215. In some embodiments, the esters of succinic acids are as described in Patent Cooperation Treaty Publication No. WO00/63261.

In some embodiments, the stereoregulating internal electron donor compound are diesters derived from esterification of aliphatic or aromatic diols. In some embodiments, the diesters are as described in Patent Cooperation Treaty Publication No. WO2010/078494 and U.S. Pat. No. 7,388,061.

In some embodiments, the internal donor is selected from 1,3-diethers. In some embodiments, the 1,3-diethers are as described in European Patent No. EP361493, European Patent No. EP728769, and Patent Cooperation Treaty Publication No.WO02/100904.

In some embodiments, the internal donor is a mixture of aliphatic or aromatic mono or dicarboxylic acid esters and 1,3-diethers as described in Patent Cooperation Treaty Publication Nos. WO07/57160 and WO2011/061134.

In some embodiments, the magnesium halide support is magnesium dihalide.

In some embodiments, the amount of internal donor that remains fixed on the solid catalyst component (1) is 5 to 20% by moles, with respect to the magnesium dihalide.

In some embodiments, the solid catalyst component (1) is prepared as described in European Patent Application No. EP395083A2.

In some embodiments, the catalyst components are prepared as described in United States Patent No. U.S. Pat. No. 4,399,054, United States Patent No. U.S. Pat. No. 4,469,648, Patent Cooperation Treaty Publication No. WO98/44009A1, and European Patent Application No. EP395083A2.

In some embodiments, the catalyst system is made from or containing an Al-containing cocatalyst (2) selected from Al-trialkyls. In some embodiments, the Al-containing cocatalyst (2) is selected from the group consisting of Al-triethyl, Al-triisobutyl, and Al-tri-n-butyl. In some embodiments, the Al/Ti weight ratio in the catalyst system is from 1 to 1000, alternatively from 20 to 800.

In some embodiments, the catalyst system is further made from or containing electron donor compound (3) (external electron donor). In some embodiments, the external electron donor is selected from the group consisting of silicon compounds, ethers, esters, amines, heterocyclic compounds, and ketones. In some embodiments, the heterocyclic compound is 2,2,6,6-tetramethylpiperidine.

In some embodiments, the silicon compounds are selected from the group consisting of methylcyclohexyldimethoxysilane (C-donor), dicyclopentyldimethoxysilane (D-donor), and mixtures thereof

In some embodiments, the polymerization is continuous or batch. In some embodiments, the polymerization is carried out in at least one polymerization stage, in liquid phase, or in gas phase.

In some embodiments, the liquid-phase polymerization is in slurry, solution, or bulk (liquid monomer). In some embodiments, the liquid-phase polymerization is carried out in various types of reactors. In some embodiments, the reactors are continuous stirred tank reactors, loop reactors, or plug-flow reactors.

In some embodiments, the gas-phase polymerization stages are carried out in gas-phase reactors. In some embodiments, the gas-phase reactors are fluidized or stirred, fixed bed reactors. In some embodiments, the gas-phase polymerization stages are carried out in a multizone reactor. In some embodiments, the gas-phase polymerization stages are as described in European Patent No. EP1012195.

In some embodiments, the reaction temperature is in the range from 40° C. to 90° C. In some embodiments, the polymerization pressure is from 3.3 to 4.3 MPa for a process in liquid phase. In some embodiments, the polymerization pressure is from 0.5 to 3.0 MPa for a process in the gas phase.

In some embodiments, the molecular weight of the polyolefin is regulated using chain transfer agents. In some embodiments, the chain transfer agent is hydrogen or ZnEtz.

In some embodiments, component (B) is a low molecular weight compound having a polar group. In some embodiments, component (B) is selected from the group consisting of aminosilanes, epoxysilanes, amidosilanes, acrylosilanes, and mixtures thereof. In some embodiments, component (B) is an aminosilane.

In some embodiments, component (B) is made from or containing a modified polymer functionalized with a polar compound and, optionally, with a low molecular weight compound having reactive polar groups. In some embodiments, the modified polymer is a polyolefin, alternatively a polyolefin selected from polyethylenes, polypropylenes, and mixtures thereof

In some embodiments, the polypropylenes are selected from the group consisting of propylene homopolymers, propylene copolymers with an alpha-olefin of formula CH₂═CHR, where R is H or a linear or branched C2-C8 alkyl, and mixtures thereof

In some embodiments, the polyethylenes are selected from the group consisting of HDPE, MDPE, LDPE, LLDPE, and mixtures thereof.

In some embodiments, the modified olefin polymer is selected from the group consisting of graft copolymers, block copolymers, and mixtures thereof.

In some embodiments, the modified polymer is made from or containing groups derived from polar compounds. In some embodiment, the polar compounds are selected from the group consisting of acid anhydrides, carboxylic acids, carboxylic acid derivatives, primary and secondary amines, hydroxyl compounds, oxazoline, epoxides, ionic compounds, and combinations thereof. In some embodiments, the polar compounds are selected from unsaturated cyclic anhydrides, aliphatic diesters, and diacid derivatives.

In some embodiments, component (B) is a polyolefin, alternatively selected from the group consisting of polyethylenes, polypropylenes, and mixtures thereof, modified with a compound selected from the group consisting of maleic anhydride, C1-C10 linear or branched dialkyl maleates, Cl-C10 linear or branched dialkyl fumarates, itaconic anhydride, Cl-C10 linear or branched itaconic acid, dialkyl esters, maleic acid, fumaric acid, itaconic acid, and mixtures thereof.

In some embodiments, component (B) is a polyethylene (MAH-g-PE) or a polypropylene (MAH-g-PP), grafted with maleic anhydride.

In some embodiments, component (B) is a polyethylene or a polypropylene grafted with maleic anhydride, having at least one of the following properties:
a maleic anhydride graft level equal to or greater than 0.25 wt. %, alternatively equal to or greater than 0.5 wt. %, alternatively of from 0.5 wt. % to 3.0 wt. %, based on the weight of component (B);
a melt flow rate MFR(B), determined according to the method ISO 1133 (190° C., 2.16 kg), ranging from 1.0 g/10 min to 50 g/10 min;
a melting temperature, determined by DSC, equal to or higher than 60° C., alternatively from 60° C. to 130° C.

In some embodiments, the polyethylene or the polypropylene, grafted with maleic anhydride, has the properties above.

In some embodiments, the modified polymers are produced by functionalization processes carried out in solution, in the solid state, or in the molten state. In some embodiments, the modified polymers are produced by functionalization processes carried out in the molten state. In some embodiments, the molten state involves reactive extrusion of the polymer in the presence of the grafting compound and of a free radical initiator. In some embodiments, the functionalization of polypropylene or polyethylene, with maleic anhydride is as described in European Patent Application No. EP0572028A1.

In some embodiments, the modified polyolefin is commercially available under the tradenames: Amplify™ TY by The Dow Chemical Company, Exxelor™ by ExxonMobil Chemical Company, Scona® TPPP by Byk (Altana Group), Bondyram® by Polyram Group, and Polybond® by Chemtura.

In some embodiments, amino resins are resins formed by condensation polymerization of a compound containing an amino group and formaldehyde. In some embodiments, component (C) is an amino resin containing an amino group selected from the group consisting of primary aliphatic amine, secondary aliphatic amine, cycloaliphatic amine, aromatic amine, polyamines, urea, urea derivatives, and mixtures thereof

In some embodiments, component (C) is selected from the group consisting of urea-formaldehyde resins, melamine-formaldehyde resins, melamine-urea copolymer resins, and mixtures thereof. In some embodiments, component (C) is a melamine-formaldehyde resin. As used herein, the term “melamine-formaldehyde resins” includes modified melamine-formaldehyde resins. In some embodiments, the modified melamine-formaldehyde resins are ether-modified melamine formaldehyde resins.

In some embodiments, the solubility in water at 25° C. of the amino resin is equal to or greater than 1% by weight, alternatively equal to or greater than 10% by weight, alternatively equal to or greater than 20% by weight. In some embodiments, the amino resin is a melamine-formaldehyde resin. In some embodiments, the upper limit of the solubility in water is 70% by weight.

In some embodiments, the amino resins are obtained by condensation processes of the monomers. In some embodiments, the amino resins are commercially available under the tradenames Saduren® from BASF, Maprenal® from Prefere Resins Holding GmbH, and Hiperesin from Chemisol Italia Srl.

In some embodiments, component (D) is selected from the group consisting of antistatic agents, anti-oxidants, slipping agents, anti-acids, melt stabilizers, nucleating agents, and combinations thereof

In some embodiments, the polymer blend is obtained/obtainable by melt blending a mixture made from or containing:
(A) 65% to 95% by weight, alternatively from 70% to 90% by weight, alternatively from 72% to 85% by weight, of a polyolefin;
(B) 0.1% to 30% by weight, alternatively 5% to 30% by weight, alternatively from 10 to 25% by weight, alternatively from 15% to 25% by weight, of a compatibilizer;
(C) 0.05% to 20% by weight, alternatively 0.05% to 10% by weight, alternatively from 0.1% to 7% by weight, alternatively from 0.5% to 5% by weight, of an amino resin; and
(D) 0% to 5.0% by weight, alternatively 0.01% to 4.0% by weight, alternatively 0.05% to 3.0% by weight, alternatively 0.06% to 2.5% by weight of an additive,
wherein the amounts of (A), (B), (C), and (D) are based on the total weight of (A)+(B)+(C)+(D), the total weight being 100%.

In some embodiments, the polymer blend is obtained/obtainable by melt blending a mixture consisting of components (A), (B), (C), and optionally (D) in the amounts indicated above. In some embodiments, the polymer blend is obtained/obtainable by melt blending a mixture consisting of components (A), (B), (C), and (D).

In some embodiments, the melt blending includes extruding components (A), (B), (C), and optionally (D) into an extruder operated at a temperature higher than the melting temperature of component (A).

In some embodiments, the melt blending process includes the steps of:
(i) providing components (A), (B), (C), and optionally (D) to an extruder, alternatively to a twin-screw extruder;
(ii) heating components (A), (B), (C), and optionally (D) to a temperature higher than the melting temperature of component (A), thereby forming a molten polymer blend;
(iii) pushing the molten polymer blend through a die and solidifying the molten polymer blend.

In some embodiments and in step (i), components (A), (B), (C), and optionally (D) are metered to the extruder simultaneously, optionally pre-mixed in the dry state. In some embodiments and in step (i), components (A), (B), (C), and optionally (D) are metered to the extruder sequentially in any order.

In some embodiments and in step (ii), components (A), (B), (C), and optionally (D) are heated to a temperature of from 180° C. to 270° C., alternatively of from 200° C. to 250° C. As used herein and in some embodiments, the temperature refers to the temperature of the head zone of the extruder.

In some embodiments, step (iii) further includes (a) pelletizing the molten polymer blend or (b) forming the molten polymer blend into a film or sheet.

In pelletizing, the molten extrudate exiting the die is cooled to solidification and subsequently cut into pellets, alternatively, the molten extrudate is cut into pellets as the molten extrudate emerges from the die, which are subsequently cooled. In some embodiments, cutting and cooling are carried out in water or air.

In some embodiments, the molten polymer blend is formed into a film or sheet by cast film/sheet extrusion or blown film/sheet extrusion. In cast film/sheet extrusion, the molten polymer blend (extrudate) exiting a linear slit die is cooled to the solid state by contact with chill rolls and wound onto reels. In blown film/sheet extrusion, the molten polymer blend (extrudate) exiting an annular die as a tube is cooled by air supplied from the inside of the tube. The inflated air prevents the film/sheet from collapsing.

In some embodiments and in step (iii), the molten polymer blend is formed into a film or sheet. In some embodiments, the melt blending process includes an additional step (iv) of stretching (orienting) the film or sheet in a direction, alternatively in two directions (machine and transverse direction). In some embodiments, stretching of the film or sheet in two directions is carried out sequentially or simultaneously. In some embodiments, sequential stretching uses a tenter frame. In some embodiments, simultaneous stretching uses a tenter frame or a tubular process.

In some embodiments, the present disclosure provides a film or sheet made from or containing the polyolefin blend. In some embodiments, the film or sheet consists of the polyolefin blend.

In some embodiments, the present disclosure provides a film or sheet obtained/obtainable by feeding the pelletized polyolefin blend to an extruder, alternatively to a twin screw extruder, remelting the pelletized polyolefin blend, and extruding the remolten polyolefin blend through a die. In some embodiments, extrusion of the remolten polyolefin blend through a die is achieved by cast film/sheet extrusion or blown film/sheet extrusion.

In some embodiments, the remelting temperature is from 180° C. to 270° C., alternatively of from 200° C. to 250° C.

In some embodiments, the film has a thickness of from 3 to 5000 μm, alternatively 10 to 2000 μm, alternatively 10 to 200 μm, alternatively 20 to 80 μm.

In some embodiments, the film or sheet is an adhesive layer in multilayer articles, thereby providing adhesion between a first layer and a second layer of different materials. In some embodiments, a first layer is made from or containing a material selected from the group consisting of metals, polymers, glass, ceramic, wood, wood-like materials, leather, cork, paper, linoleum, and combinations thereof. In some embodiments, a second layer is a thermoplastic polymer layer, alternatively a thermoplastic polyolefin layer.

In some embodiments, the films or sheets are a bonding layer, thereby promoting adhesion of a first layer made from or containing a thermoplastic polymer to a second layer made from or containing a material selected from the group consisting of metals, polymers, glass, ceramic, wood, wood-like materials, leather, cork, paper, linoleum, and combinations thereof

In some embodiments, the present disclosure provides a multilayer article made from or containing a backing layer, an upper layer, and a bonding layer interposed between the backing layer and the upper layer, wherein the backing layer is made from or containing a thermoplastic polymer, the bonding layer is made from or containing the film or sheet, and the upper layer is made from or containing a material selected from the group consisting of metals, polymers, glass, ceramic, wood, wood-like materials, leather, cork, paper, linoleum, and combinations thereof

In some embodiments, the bonding layer consists of the film or sheet.

In some embodiments, the backing layer is made from or containing a thermoplastic polyolefin selected from the group consisting of polyethylene, polypropylene, polybutene-1, polyvinyl chloride, polyether, polyketone, polyetherketone, polyester, polyacrylate, polymethacrylate, polyamide, polycarbonate, polyurethane, polythiophenylene, polybutene terephthalate, polystyrene, and mixtures thereof.

In some embodiments, the backing layer is made from or containing a polyolefin selected from the group consisting of polypropylene, polyethylene, polybutene-1, and mixtures thereof. In some embodiments, the backing layer is made from or containing a propylene polymer selected from the group consisting of propylene homopolymers, propylene copolymers with an alpha-olefin of formula CH₂═CHR, where R is H or a linear or branched C2-C8 alkyl, and mixtures thereof. In some embodiments, the alpha-olefin is selected from the group consisting of ethylene, butene-1, hexene-1, 4-methy-pentene-1, octene-1, and combinations thereof. In some embodiments, the alpha-olefin is ethylene.

In some embodiments, the propylene copolymer is a random propylene copolymer or an heterophasic propylene polymer made from or containing a matrix and a dispersed elastomeric phase, wherein the matrix is made from or containing a propylene homopolymer, a random propylene copolymer, or a combination thereof, and the dispersed phase is made from or containing a propylene copolymer made from or containing 15-80% by weight of monomer units deriving from an alpha-olefin of formula CH₂═CHR, where R is H or a linear or branched C2-C8 alkyl and mixtures thereof. In some embodiments, the random propylene copolymer is made from or containing 0.1-15% by weight of an alpha-olefin. In some embodiments, the alpha-olefin is selected from the group consisting of ethylene, butene-1, hexene-1, octene-1, and combinations thereof

In some embodiments, the backing layer optionally is made from or containing up to 60% by weight, alternatively 1-60% by weight, of an additive selected from the group consisting of fillers, pigments, dyes, extension oils, flame retardants, UV resistants, UV stabilizers, lubricants, antiblocking agents, slip agents, waxes, coupling agents for fillers, and combinations thereof, based on the weight of the backing layer. In some embodiments, the flame retardant is aluminum trihydrate. In some embodiments, the UV resistant is titanium dioxide. In some embodiments, the lubricant is oleamide.

In some embodiments, the backing layer is made from or containing a thermoplastic polyolefin, alternatively a propylene polymer as described above, and up to 40% by weight, alternatively 10-40% by weight, alternatively 20-40% by weight, of a mineral filler, based on the weight of the backing layer. In some embodiments, the mineral filler is talc.

In some embodiments, the backing layer consists of the thermoplastic polymer, alternatively the polyolefin, described above.

In some embodiments, the backing layer consists of the thermoplastic polymer, alternatively the polyolefin, described above and the additive.

In some embodiments, the polymers for the upper layer are thermoplastic polymers or thermoset polymers. In some embodiments, the backing layer is made from or containing the thermoplastic polymers. In some embodiments, the upper layer consists of a polymer composition made from or containing at least two polymers. In some embodiments, the polymer composition is an heterophasic composition made from or containing a matrix phase and an elastomeric phase.

In some embodiments, the upper layer is made from or containing metals selected from the group consisting of aluminum, copper, iron, steel, titanium, lithium, gold, silver, manganese, platinum, palladium, nickel, cobalt, tin, vanadium, chromium, alloys made from or containing the metals, and combinations thereof. In some embodiments, the alloy is brass.

In some embodiments, the backing layer and the upper layer are independently in the form of a coat, film, sheet, woven or nonwoven fabric, web, or foam.

In some embodiments, the backing layer has a thickness from 3μm to 2.0 cm, alternatively from 100 μm to 5.0 mm.

In some embodiments, the upper layer has a thickness from 1μm to 2.0 mm, depending on the material.

In some embodiments, the multilayer article consists of the backing layer, the bonding layer, and the upper layer.

In some embodiments, the film or sheet bonds a backing layer made from or containing a polyolefin to an upper metallic layer.

In some embodiments, the multilayer article is made from or containing a backing layer made from or containing a polyolefin, alternatively a propylene polymer, an upper metallic layer, and a bonding layer interposed between backing layer and the upper layer, wherein the bonding layer is made from or containing a film or sheet. In some embodiments, the upper metallic layer is made from or containing a metal selected from the group consisting of aluminum, copper, iron, steel, titanium, lithium, gold, silver, manganese, platinum, palladium, nickel, cobalt, tin, vanadium, chromium, alloys made from or containing the metals, and combinations thereof. In some embodiments, the upper metallic layer is made from or containing aluminum. In some embodiments, the alloy is brass.

In some embodiments, the backing layer has a thickness from 100 μm to 5000 μm, alternatively from 200 μm to 3000 μm. In some embodiments, the bonding layer has thickness a from 10 to 2000 μm, alternatively 10 to 200 μm, alternatively 20 to 80 μm. In some embodiments, the upper metallic layer has a thickness from 1 to 1000 μm, alternatively from 10 to 500 μm, alternatively from 50 to 300 μm. In some embodiments, the upper layer, the bonding layer, and the backing layer have a thickness in the ranges above.

In some embodiments, the multilayer article is further made from or containing additional layers. In some embodiments, an additional layer is a reinforcing layer adhered to the surface of the backing layer opposite to the surface onto which the bonding layer is arranged. In some embodiments, an additional layer is a coating layer adhered to the surface of the upper layer opposite to the surface onto which the bonding layer is arranged.

In some embodiments, the present disclosure provides a process for preparing the multilayer article selected from the group consisting of coextrusion, lamination, extrusion lamination, compression molding, back injection molding, back foaming, back compression molding, and combinations thereof

In coextrusion, the multilayer article is formed by cooling an extrudate made from or containing a first, a second, and a third superimposed melt streams, wherein the first melt stream is made from or containing the thermoplastic polymer of the backing layer, the second melt stream is made from or containing the polyolefin blend of the bonding layer, and the third melt stream is made from or containing the material of upper layer. In some embodiments, the material of the upper layer is made from or containing a thermoplastic or a thermoset polymer.

In lamination, a film or sheet made from or containing the materials forming the backing layer, the bonding layer, and the upper layer are made to adhere using heated compression rollers.

In extrusion lamination, a first film or sheet made from or containing the material of the backing layer and a second film or sheet made from or containing the material of the upper layer are laminated with heated compression roller while the polymer blend is extruded between the first and second films or sheets, thereby acting as a bonding layer.

In compression molding, a film or sheet made from or containing the materials forming the backing layer, the bonding layer, and the upper layer are made to adhere by putting the superimposed films into an open heated cavity of a mold, closing the mold with a plug member, and subsequently applying pressure. In some embodiments, the film or sheet is shaped in the mold.

In some embodiments, the multilayer article is obtained/obtainable by back injection molding.

In some embodiments and in the back injection molding process, a film or sheet made from or containing the material of the backing layer is introduced into one half of the injection mold and a film or sheet made from or containing the material of the upper layer is introduced into the other half of the injection mold. In some embodiments, the polyolefin blend of the bonding layer is injected into the mold between the backing layer and the upper layer, at a temperature of from 160° C. to 270° C. and a pressure of from 0.1 to 200 MPa, thereby bonding the layers.

In some embodiments and in the back injection molding process, a film or sheet made from or containing the polymer blend is laminated to a film or sheet made from or containing the material of upper layer. In some embodiments, the laminated film or sheet is introduced into an injection mold, with the upper layer facing the mold. The material forming the backing layer is injected into the mold and bonded to the laminate. In some embodiments, multilayer articles made from or containing an upper metallic layer are obtained/obtainable via this back injection molding process.

In some embodiments, the present disclosure provides a (intermediate) composite film or sheet made from or containing a metallic layer and a bonding layer adhered thereto, wherein the metallic layer is made from or containing a metal selected from the group consisting of aluminum, copper, iron, steel, titanium, lithium, gold, silver, manganese, platinum, palladium, nickel, cobalt, tin, vanadium, chromium, alloys comprising the metals, and combinations thereof, and the bonding layer made from or containing the polymer blend. In some embodiments, the metal is aluminum. In some embodiments, the alloy is brass.

In some embodiments and in the (intermediate) composite film or sheet, the thickness of the upper metallic layer is from 1 to 1000 μm, alternatively from 10 to 500 μm, alternatively from 50 to 300 μm, alternatively 20 to 80 μm, and the thickness of the bonding layer is from 10 to 2000 μm, alternatively 10 to 200 μm, alternatively 20 to 80 μm.

The features describing the subject matter of the present disclosure are not inextricably linked to each other. In some embodiments, a level of a feature does not involve the same level of the remaining features of the same or different components. In some embodiments, a range of features of components from (A) to (D) is combined independently from the level of the other components, and that components from (A) to (D) is combined with an additional component and the component's features.

### EXAMPLES

The following examples are illustrative and not intended to limit the scope of the disclosure in any manner whatsoever.

### Characterization Methods

The following methods are used to determine the properties indicated in the description, claims and examples.

Melt Flow Rate: Determined according to the method ISO 1133 (230° C., 2.16 Kg for the thermoplastic polyolefins; 190° C./2.16 Kg for the compatibilizer).

Solubility in xylene at 25° C.: 2.5 g of polymer sample and 250 ml of xylene were introduced into a glass flask equipped with a refrigerator and a magnetic stirrer. The temperature was raised in 30 minutes up to 135° C. The resulting clear solution was kept under reflux and stirred for further 30 minutes. The solution was cooled in two stages. In the first stage, the temperature was lowered to 100° C. in air for 10 to 15 minutes under stirring. In the second stage, the flask was transferred to a thermostatically-controlled water bath at 25° C. for 30 minutes. The temperature was lowered to 25° C. without stirring during the first 20 minutes and maintained at 25° C. with stirring for the last 10 minutes. The formed solid was filtered on quick filtering paper (for example, Whatman filtering paper grade 4 or 541). 100 ml of the filtered solution (S1) was poured into a pre-weighed aluminum container, which was heated to 140° C. on a heating plate under nitrogen flow, thereby removing the solvent by evaporation. The container was then kept in an oven at 80° C. under vacuum until constant weight was reached. The amount of polymer soluble in xylene at 25° C. was then calculated. XS(I) and XS_{A} values were experimentally determined. The fraction of component (B) soluble in xylene at 25° C. (XS_{B}) was calculated from the formula:

XS=W(A)×(XS_{A})+W(B)×(XS_{B})

wherein W(A) and W(B) are the relative amounts of components (A) and (B), respectively, and W(A)+W(B)=1.

C2 content in propylene-ethylene copolymer (II): ¹³C NMR spectra were acquired on a Bruker AV-600 spectrometer equipped with cryoprobe, operating at 160.91 MHz in the Fourier transform mode at 120° C. The peak of the P_{ββ} carbon (nomenclature according to C. J. Carman, R. A. Harrington and C. E. Wilkes, Macromolecules, 10, 3, 536 (1977)) was used as internal standard at 2.8 ppm. The samples were dissolved in 1,1,2,2-tetrachloroethane-d2 at 120° C. with an 8% wt/v concentration. Each spectrum was acquired with a 90° pulse, 15 seconds of delay between pulses and CPD, thereby removing ¹H-¹³C coupling. 512 transients were stored in 32K data points using a spectral window of 9000 Hz. The assignments of the spectra, the evaluation of triad distribution and the composition were made according to Kakugo [M. Kakugo, Y. Naito, K. Mizunuma and T. Miyatake, Macromolecules, 16, 4, 1160 (1982)]. In view of the amount of propylene inserted as regioirregular units, ethylene content was calculated according to Kakugo [M. Kakugo, Y. Naito, K. Mizunuma and T. Miyatake, Macromolecules, 16, 4, 1160 (1982)] using triad sequences with P inserted as regular unit.

PPP=100 T_{ββ}/S

PPE=100 T_{βδ}/S

EPE=100 T_{δδ}/S

PEP=100 S_{ββ}/S

PEE=100 S_{βδ}/S

EEE=100 (0.25 S_{γδ}+0.5 S_{δδ})/S

where S=T_{ββ}+T_{βδ}+T_{δδ}+S_{ββ}+S_{βδ}+0.25 S_{γδ}+0.5 S_{δδ}

Melting temperature: by DSC.

Tensile Modulus: Determined according to the method ISO 527-1,-2:2019.

Peel test: 90° peel test was performed according to DIN EN 1272 on a Zwicki Z1.0 testing machine from ZwickRoell GmbH & Co. KG, Germany. Five tests were performed for each material combination. Along the longest axis, the aluminum foil was manually separated from the laminate starting from a first side over a length of 6 cm and the separated part of the aluminum foil was clamped into the testing machine at a 90° angle to the laminate and tested with a test speed of 100 mm/min. A load cell on the upper traverse was used to continuously measure the force to peel off the test specimens. From the plateau (traverse travel between approximately 15 mm and 80 mm), the peel force Fₚₑₑₗ was determined by arithmetically averaging the measured tensile forces in the plateaus. The peel resistance Rₚₑₑₗ was calculated according to the formula:

$${R}_{peel} [ \frac{N}{mm} ] = \frac{{F}_{peel}}{b}$$

wherein b is the width of the aluminum/foil laminate which was set at 25 mm.

### Raw Materials:

Moplen HF501N, a propylene homopolymer commercially available from LyondellBasell, having a melt flow rate of 12 g/10 min. (ISO1133; 230° C./2.16 Kg) and tensile modulus of 1550 MPa.

Amplify TY 1060H maleic anhydride (MAH) grafted polymer concentrate with MAH grafting level of 0.5-1.0 wt. %, commercially available from The Dow Chemical Company, having a MFR of 3.0 g/10 min. (ISO1133; 190° C./2.16 Kg) and melting temperature of 62.8° C.

Hiperesin MF 100C melamine-formaldehyde powder resin, commercially available from Chemisol Italia, having solubility in water in the range 30-65 wt. %.

Hostacom DKC 2066T, a low shrinkable propylene-based thermoplastic polyolefin, commercially available from LyondellBasell containing 30 wt. % of talc.

### Example E1 and Comparative Example CE2

Preparation of the bonding film: the mixtures, having the composition reported in Table 1, were fed to a twin-screw extruder ZSK-25 (Coperion GmbH, Stuttgart, Germany), operating with a throughput of 10 kg/h at 210 ° C. The melt was pelletized through a die plate having 4 holes of 2 mm diameter, thereby resulting in granules of a polymer blend. The granules of polymer blend were fed to a blown film line (HOSOKAWA ALPINE AG., Augsburg, Germany), equipped with a 55 mm diameter single screw extruder, and blown into a film employing a throughput of 40 kg/h and a temperature of 210 ° C. in the head zone of the extruder. The extruded bubbles had a diameter of 800 mm. The bubbles were cut. The resulting films, having a thickness of 40 μm, were wound onto a roll.

Preparation of the laminate: the films were first laminated to an aluminum foil DPxx (anodized open pored) 200 μm thick, obtained from Alanod GmbH & Co. KG, Germany. The lamination was carried out continuously using a laminator UVL PRO 2911039 from Fetzel Maschinenbau GmbH, Germany with silicone rollers LA6OAC0.01 at 170 ° C. and 15 bar/(m²) surface pressure. The intake speed was 0.2 mm/min. The laminates were cut into pieces of size 200×25 mm.

Preparation of the multilayer article: the laminates were back-injected into an injection molding machine KM350-2000CX from KraussMaffei, Germany. A mold of the size 205×143×2 mm was used. The laminates were inserted with the aluminum layer facing the mold wall and the bonding layer in the direction of the thermoplastic polymer to be injected. Hostacom DKC 2066T was injected into the mold. Injection molding conditions are listed in Table 2.

TABLE 1
composition of the mixture

| | | E1 | CE2 |
|---|---|---|---|
| Moplen HF501N | wt. % | 78.8 | 79.6 |
| Amplify TY 1060 | wt. % | 20.0 | 20.2 |
| Hiperesin MF 100C | wt. % | 1.0 | / |
| Stabilizers(*) | wt. % | 0.2 | 0.2 |

(*) Irganox® 1010 and Irgafos 168®, commercially available from BASF, 0.1 wt. % each. Irganox® 1010 is 2,2-bis[3-[,5-bis(1,1-dimethylethyl)-4-hydroxyphenyl]-1-oxopropoxy]methyl]-1,3-propanediyl-3,5-bis(1,1-dimethylethyl)-4-hydroxybenzene-propanoate. Irgafos® 168 is tris(2,4-di-tert.-butylphenyl)phosphite.

TABLE 2
injection molding conditions

| Parameter | | Value |
|---|---|---|
| Temperature (Heating zones 1\|2\|3\|4) | ° C. | 200\|210\|220\|230 |
| Temperature nozzle | ° C. | 230 |
| Mold temperature | ° C. | 40 |
| Injection speed | mm/s | 18 |
| Injection time | s | 2 |
| Packing pressure | bar | 500 |
| Packing time | s | 16 |
| Cooling time | s | 15 |
| Cycle time | s | 41 |

The results of the peel test are reported in Table 3.

TABLE 3
peel test

| | Peel resistance Rpeel [N/mm] |
|---|---|
| Example E1 | 3.04 ± 0.17 |
| Comparative example CE2 | 0.08 ± 0.02 |

1. A polymer blend obtained by melt blending a mixture comprising:
(A) 60% to 98.8% by weight of a polyolefin;
(B) 0.1% to 30% by weight a compatibilizer;
(C) 0.05% to 20% by weight of an amino resin; and
(D) 0% to 5% by an additive,
wherein the amounts of (A), (B), (C),. and (D) are based on the total weight of (A)+(B)+(C)+(D), the total weight being 100%.

2. The polymer blend according to claim 1, wherein the component (A) is a propylene polymer selected from the group consisting of propylene homopolymers or propylene copolymers with an alpha-olefin of formula CH₂═CHR, where R is H or a linear or branched C2-C8 alkyl.

3. The polymer blend according to claim 1, wherein component (B) is a polyolefin modified with a compound selected from the group consisting of maleic anhydride, C1-C10 linear or branched dialkyl maleates, C1-C10 linear or branched dialkyl fumarates, itaconic anhydride, C1-C10 linear or branched itaconic acid, dialkyl esters, maleic acid, fumaric acid, itaconic acid and mixtures thereof.

4. The polymer blend according to claim 1, wherein the component (C) is selected from the group consisting of urea-formaldehyde resins, melamine-formaldehyde resins, melamine-urea copolymer resins, and mixtures thereof.

5. The polymer blend according to claim 1, wherein component (D) is selected from the group consisting of antistatic agents, anti-oxidants, slipping agents, anti-acids, melt stabilizers, nucleating agents and combinations thereof.

6. The polymer blend according to claim 1, wherein the melt blending comprises extruding components (A), (B), (C), and optionally (D) into an extruder operated at a temperature higher than the melting temperature of component (A).

7. The polymer blend according to claim 1, wherein the melt blending comprises the steps of:
(i) providing components (A), (B), and optionally (D) to an extruder;
(ii) heating components (A), (B), and optionally (D), to a temperature higher than the melting temperature of component (A), thereby forming a molten polymer blend; and
(iii) pushing the molten polymer blend through a die and solidifying the molten polymer blend.

8. The polymer blend of claim 7, wherein the step (iii) further comprises (a) pelletizing the molten polymer blend, thereby forming a pelletized polyolefin blend, or (b) forming the molten polymer blend into a film or sheet.

9. A film or sheet comprising the polyolefin blend as according to claim 1.

10. (canceled)

11. The film according to claim 9, having a thickness of from 3 to 5000 μm.

12. A multilayer article comprising a backing layer, an upper layer, and a bonding layer interposed between the backing layer and the upper layer, wherein the backing layer comprises a thermoplastic polymer, the bonding layer comprises the film or sheet according to claim 9, and the upper layer comprises a material selected from the group consisting of metals, polymers, glass, ceramic, wood, wood-like materials, leather, cork, paper, linoleum and combinations thereof

13. The multilayer article according to claim 12, wherein the thermoplastic polymer is selected from the group consisting of polyethylene, polypropylene, polybutene-1, polyvinyl chloride, polyether, polyketone, polyetherketone, polyester, polyacrylate, polymethacrylate, polyamide, polycarbonate, polyurethane, polythiophenylene, polybutene terephthalate, polystyrene,. and mixtures thereof.

14. The multilayer article according to claim 12, wherein the upper layer comprises a metal selected from the group consisting of aluminum, copper, iron, steel, titanium, lithium, gold, silver, manganese, platinum, palladium, nickel, cobalt, tin, vanadium, chromium, alloys comprising the metals, and combinations thereof.

15. (canceled)

16. (canceled)

17. The film or sheet according to claim 9, wherein the melt blending comprises the steps of:
(i) providing components (A), (B), (C), and optionally (D) to an extruder;
(ii) heating components (A), (B), (C), and optionally (D) to a temperature higher than the melting temperature of component (A), thereby forming a molten polymer blend;
(iii) pushing the molten polymer blend through a die and pelletizing the molten polymer blend, thereby forming a pelletized polyolefin blend; and
(iv) feeding the pelletized polyolefin blend to an extruder, remelting the pelletized polyolefin blend, and extruding the remolten polyolefin blend through a die, thereby forming the film or sheet.
